(19) United States
(12) Patent Application Publication
(10) Pub. No.: US 2004/0200896 A1
(43) Pub. Date: Oct. 14, 2004

(54) Apparatus for storing and transferring personal data

(76) Inventor: Marcus Eckerl, Montreal (CA)

Correspondence Address: MCCARTHY TETRAULT LLP, SUITE 4900, P.O. BOX 48, 66 WELLINGTON ST. WEST, TORONTO, ON, M5K 1E6, CA

(21) Appl. No.: 10/412,296

(22) Filed: Apr. 14, 2003

(51) Int. Cl. G06K 5/00; G06F 17/60

(52) U.S. Cl. 235/380

(57) ABSTRACT

An apparatus is provided that is enabled to store and transmit at least one set of data stored therein. In one embodiment, the apparatus includes a simple user interface that comprises one or more buttons and light-emitting diodes. The buttons are configured to select and transmit a set of data stored within the apparatus, and the diodes are configured to provided information regarding the operation of the apparatus to a user of the apparatus. The apparatus includes a number of hardware and software elements that enables the apparatus to exchange data with another similar apparatus and other devices. The embodiment also provides communications between the apparatus and a personal computer, by additionally utilizing other hardware and software elements operating on the personal computer.

### FIELD OF THE INVENTION

The present invention relates to an apparatus and method for storing, transferring and receiving personal data, such as contact information typically found in a business card (names, company names, phone numbers, addresses etc.). In particular, the invention provides an apparatus which stores and selectively transmits such data to other devices.

### BACKGROUND OF INVENTION

Traditionally, personal contact information, such as names, telephone numbers and mailing addresses, is exchanged using known paper-based business cards between two or more people. More recently, the traditional business card paradigm has been digitized, wherein such information is digitally stored in an electronic device and exchanged with other electronic devices.

Existing electronic devices that store and exchange information associated with business cards includes notebook computers, handheld computers, personal digital assistants, personal organizers, and personal communicators such cellular telephones. Such electronic devices generally provide multiple functions, and typically allow a certain level of programmability, in addition to storage and exchange of information associated with business cards. To offer this additional functionality and programmability, such devices are generally characterized by having significant processing power, storage capability, and power requirement, and to provide this processing power, storage and power requirement, such devices are generally of a relatively large size that is at least as difficult to carry as known business card-holders of paper business cards. Furthermore, because of the multiple functions that is provided, such electronic devices generally requires a user of to execute many, perhaps complicated, steps to navigate through the menus and options provided by such devices before the information associated with business cards can be exchanged.

Therefore, there is a need for a system to store and exchange such data having an intent of addressing these deficiencies.

### SUMMARY OF INVENTION

In a first aspect an apparatus for storing sets of identification data and for transmitting a selected set therefrom is provided. The apparatus comprises an electronic storage device, a selection interface module, a transmission module, an indication module, a processing module and a power module. The electronic storage device stores the sets of identification data. The selection interface module enables a user to identify the selected set from the sets of identification data. The transmission module transmits the selected set from the apparatus. The indication module provides a detectable indication to the user when the user activates the selection interface module. The processing module controls operation of the electronic storage device, the selection interface module, the transmission module and the indication module. The power module provides power to the apparatus and the above modules.

In the apparatus, the selection interface module may comprise a first input device providing identification of the selected set from the sets of identification data and a second input device enabling initiation of transmission of the selected set by the apparatus.

In the apparatus, the selection interface module may comprise a first input device and a second input device. The first input device is associated with a first set of the sets, the first set becoming the selected set upon activation of the first input device. The second input device is associated with a second set of the sets, the second set becoming the selected set upon activation of the second input device.

The apparatus may further comprise a receiving module for receiving an external set of identification data from another apparatus, wherein the processing module further controls operation of the receiving module and the external set of identification data is stored in the electronic storage device.

In the apparatus, the indication module may comprise a light emitting source energized upon activation of the selection interface module.

The apparatus may further comprise a synchronization module for initiating communications with an external device to attempt to coordinate transmission of the selected set and the external set between the devices.

In the apparatus, the synchronization module may transmit a link request signal to the external device and may then wait for reception of an acknowledgement signal from the external device for a period of wait time. Preferably, this is done to establish an order of transmission of the first set by the apparatus and the external set by the another apparatus prior to transmission of the selected set by the apparatus.

In the apparatus, if the synchronization module receives the acknowledgement signal within the period of wait time, then the synchronization module may generate and transmit a signal to the another apparatus to begin transmitting the external data set to the apparatus.

In the apparatus, after successful reception of the external data set, the transmission module may begin transmitting the selected set from the apparatus.

In the apparatus the external set may be stored in the electronic storage module.

In the apparatus, the transmission module may transmit the selected set utilizing wireless transmissions.

In a second aspect, a system for storing of sets of identification data is provided. The system includes an apparatus, software operating on a computer and an interface module associated with the computer. The apparatus comprises an electronic storage device, a selection interface module, a transmission module, an indication module, a processing module and a power module. The electronic storage device stores the sets of identification data. The selection interface module enables a user to identify the selected set from the sets of identification data. The transmission module transmits the selected set from the apparatus. The indication module provides a detectable indication to the user when the user activates the selection interface module. The processing module controls operation of the electronic storage device, the selection interface module, the transmission module and the indication module. The power module provides power to the apparatus and the above modules. The software comprises an input module, a transmission module and a reception module. The input module receives data from the computer constituting the identification set. The transmission module controls transmission of the identification set to the apparatus and establishes synchronization with the apparatus. The reception module initiates transmission of one of the sets of identification data from the apparatus to the computer for storage by the computer. The interface module transmits the identification set to the apparatus from the computer as controlled by the software and receives data from the apparatus.

In the system, the transmission module of the software may initiate transmission of a link request signal to apparatus and thereafter may wait for reception of an acknowledgement signal from the apparatus before transmitting a signal to the identification set to the apparatus.

In the system, activation of the selection interface module to a selection may cause the identification set to be associated with that selection by the apparatus.

In the system, the software may further comprise a reset module to initiate a request to the apparatus to clear the electronic memory device of all identification data.

In the system, the reception module of the software may further include a routine to initiate a request to request to the apparatus to transmit all of sets of identification data to the computer.

In other aspects of the invention, various combinations and subset of the above aspects are provided.

### BRIEF DESCRIPTION OF THE DRAWINGS

The foregoing and other aspects of the invention will become more apparent from the following description of specific embodiments thereof and the accompanying drawings which illustrate, by way of example only, the principles of the invention. In the drawings, where like elements feature like reference numerals (and wherein individual elements bear unique alphabetical suffixes):

FIG. 1 is a perspective view of an exemplary embodiment of a device embodying the invention;

FIG. 2 is a block diagram of the device of FIG. 1 communicating with a second device and with other electronic devices;

FIG. 3 is a block diagram of hardware elements of the device of FIG. 1;

FIG. 4 is a block diagram of modules of a software program which operates in the device of FIG. 1;

FIG. 5 is a flow chart of operation of the software program of FIG. 4;

FIG. 6 is a block diagram of two parts of a more detailed flow chart of FIG. 5;

FIG. 6(i) is a block diagram of a first part of the more detailed flow chart of FIG. 6;

FIG. 6(ii) is a block diagram of a second part of the more detailed flow chart of FIG. 6;

FIG. 7 is a block diagram of an exemplary computer interface program operating on a personal computer for communication with the device of FIG. 1; and

FIG. 8 is a pictorial representation of a window generated by a software interface of the computer interface program of FIG. 7 for presentation to a user on a personal computer.

### DETAILED DESCRIPTION OF EMBODIMENT

The description which follows, and the embodiments therein, are provided by way of illustrating an example, or examples, of particular embodiments of principles of the present invention. These examples are provided for the purpose of explanation, and not limitations, of those principles. In the description, which follows, like elements are marked throughout the specification and the drawings with the same respective reference numerals.

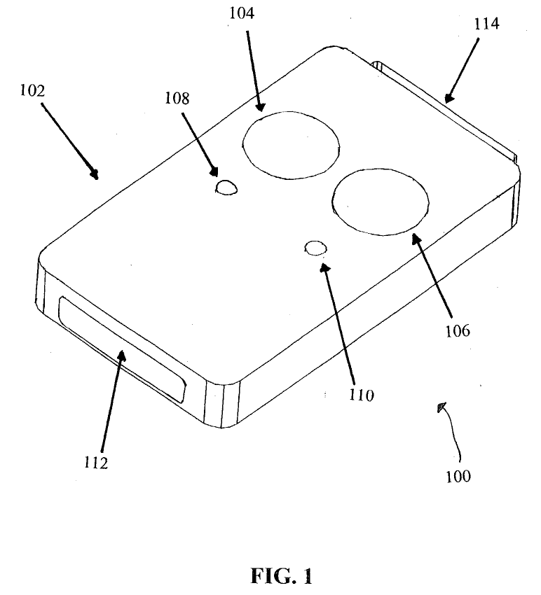

Referring to FIG. 1, device 100 is shown representing an embodiment of the invention. As will be described later in further detail, device 100 is enabled to store and transmit at least one set of data thereon. Preferably, device 100 is enabled to store at least 63 sets of data, of which two may be selectively transmitted from device 100. Each set of data may be identification data or contact data, such as personal name, title, company name, telephone number, email address etc. For an embodiment, one set may relate to contact information associated, for example, with an office address for a person and another set may relate to contact information associated with a home address for that person. It will be appreciated that other types of data may be stored in each set in other embodiments. For example, one set of data may relate to medical information and the other set of data may relate to account information. It will be appreciated by those skilled in the art that the type of information stored in each data set, per se, may not necessarily be restricted to forms of contact information. As will be described later in detail, the embodiment enables either set of such data to be selectively transmitted to other external devices, including other similar devices 100.

Device 100 comprises case 102 having buttons 104 and 106, light emitting diodes (“LEDs”) 108 and 110, data communication port 112 and a key-ring 114. Key-ring 114 provides a loop for attaching device 100 to a key-ring or key-chain.

Preferably, case 102 has exterior dimensions of approximately, 6.3 cm long by 3.5 cm wide by 0.8 cm tall. However, any self-contained suitably small form factor for case 102 may be used in other embodiments. It will be appreciated that a small size for device 100 facilitates its attachment to a key-ring enabling device 100 to be easily carried with a user in his pocket or elsewhere on his person.

As noted above, device 100 preferably enables two sets of contact data stored therein to be transmitted from device 100. Each set of data is independently accessible and transferable from device 100 to other devices. In device 100, activation of button 104 or 106 by a user causes hardware and software elements of device 100 (described in further detail below) to access a set of contact data associated with the activated button and attempt to transmit that data to an external device via data communication port 112. Preferably port 112 is enabled to transmit and receive data as infrared signals. As such, port 112 (and its associated interface) is enabled to receive data to be transmitted from hardware and software elements in device 100, convert it to an infrared signal and transmit the infrared signal from device 100. However, it will be appreciated by those skilled in the art that other transmission methods may be utilized in other embodiments of port 112, including ultrasonic, optical, radio and electrical signal transmission methods and systems.

When button 104 or 106 is activated, preferably LED 108 is activated by other hardware and software elements of device 100 (described below), indicating that device 100 is powered on and that a data set of device 100 is being accessed. Activation of button 104 or 106 further causes the accessed data set to be transmitted from device 100 via port 112. A second LED 110 is provided which is activated if an error condition occurs. In the preferred embodiment, LED 108 illuminates in green and LED 110 illuminates in red. Buttons 104 and 106 are input devices and provide a selection interface module for the sets of contact data stored in device 100. Additionally, buttons 104 and 106 provide a user interface to activate device 100. With buttons 104 and 106 as provided, only a single button needs to be pressed in order to activate device 100 and to cause the transmission of the selected contact data from device 100. Alternative selection interface modules may have a series of input devices (not shown), wherein one button enables the user to select from the stored contact data and another button enables the transmission of the selected contact data.

In the embodiment, buttons 104 and 106 are debounced to eliminate spurious activation/deactivation signals and are associated with “single-shot” circuits, enabling a user to simply depress either button 104 or 106, then release it after a certain amount of time, to activate exchange of contact data between the device 100 and an external device, without requiring the user to keep the button depressed for the entire duration of the exchange. In the embodiment, the single shot circuits require that a button be depressed for approximately two seconds before device 100 activates and begins the exchange of data with an external device. Thereafter, further depressions of either button will not affect the subsequent operation of device 100. Such debounce and single-shot circuits may incorporate hardware and software elements using techniques known in the art.

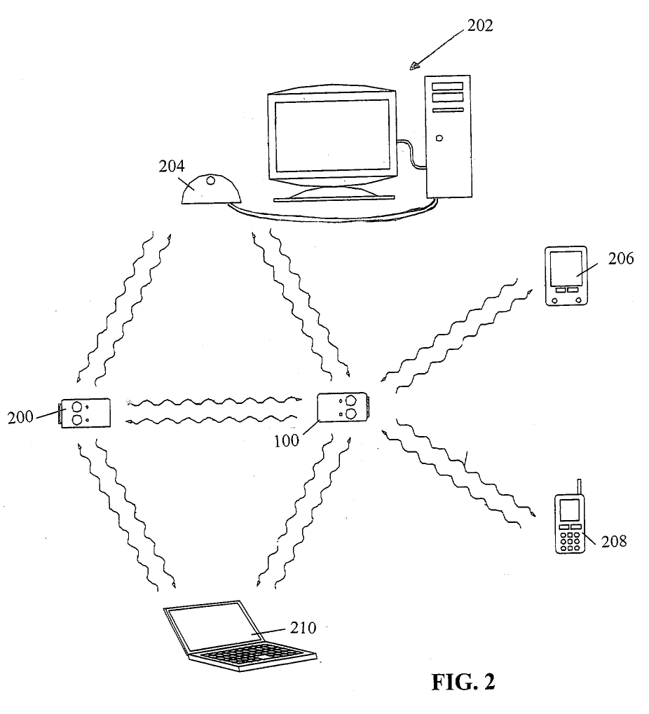

Referring to FIG. 2, device 100 is shown in communications with a similar device 200, a notebook computer 210, a cellular telephone 208, a personal digital assistant (“PDA”) 206, or a personal computer 202. As noted above, device 100 communicates data with other external devices via port 112. As such, each of device 200, notebook computer 210, cellular telephone 208, and PDA 206 must have an interface for communicating data to and from port 112. As personal computer 202 may not have a compatible communication port as part of its standard equipment, personal computer 202 may be connected to a separate communications transceiver 204 to enable communications with device 100.

As will be explained in further detail below, when device 100 communicates with other devices 100, each device 100 must synchronize its communications with the other devices. In the embodiment, synchronization is achieved via an exchange of synchronization messages between the devices. Once full synchronization is achieved, one device becomes a master and the other becomes a slave. The synchronization messages are generated by each device depending on its current state of operation and transmitted through its respective port 112. Generally, a link request signal is an initial message that is sent by a first transmitting device. If a second device receives the link request signal, the second device responds by sending an acknowledgement signal. Successful receipt of the acknowledgement signal by the first device completes the synchronization.

An exemplary synchronization of the device is provided. If a user of device 100 desires to exchange contact data with a user of another apparatus 100, the users would each depress an activation button on their respective devices and one or more link request signals are sent from each device. Each device waits for a first period of time to receive an acknowledgement signal. If none is received, then the device stops listening for an acknowledgement signal, and begins to listen for a link request signal for a second period of time. If a link request is received, then the device immediately responds by sending an acknowledgement signal and waits for other command signals from the other device. However, if no link request signal is detected after the second period of time, then the device stops waiting for a link request signal and sends a subsequent link request signal, and then waits for an acknowledgment signal as above. This cycle is repeated until either device 100 receives either an acknowledgement signal, a link request signal or until a timeout condition occurs. In the embodiment, the first wait period is much longer than the second wait period, for example, twenty times longer. If neither device receives an acknowledgment signal to a link request signal after a number of link request signals were sent, then a timeout condition occurs and each device deactivates itself.

Once two devices have successfully synchronized by exchanging a link request signal and an acknowledgement signal, then the devices exchange contact data sets. Control of the exchange occurs preferably via one of two manners. In the first manner, device 100A had initially sent a link request signal to device 100B and device 100B had successfully received the signal and sent an acknowledgement signal to device 100A. Upon receipt of the link request signal, device 100B is deemed to be a slave. Upon receipt of the acknowledgement signal, device 100A is deemed to be a master. As the master, device 100A issues command signals to device 100B for device 100B to provide its data to device 100A, and device 100A receives and stores the sent data. Also as the master, device 100A provides its data to device 100B and issues command signals for device 100B to receive and store the sent data. As the slave, device 100B listens for and acts upon command signals issued by device 100A, including signals to (i) provide its data, and (ii) receive and store data sent from device 100A. In the second manner, the roles are reversed and device 100B is a master that issues command signals to a slave while device 100A is the slave that listens for and acts upon the issued command signals.

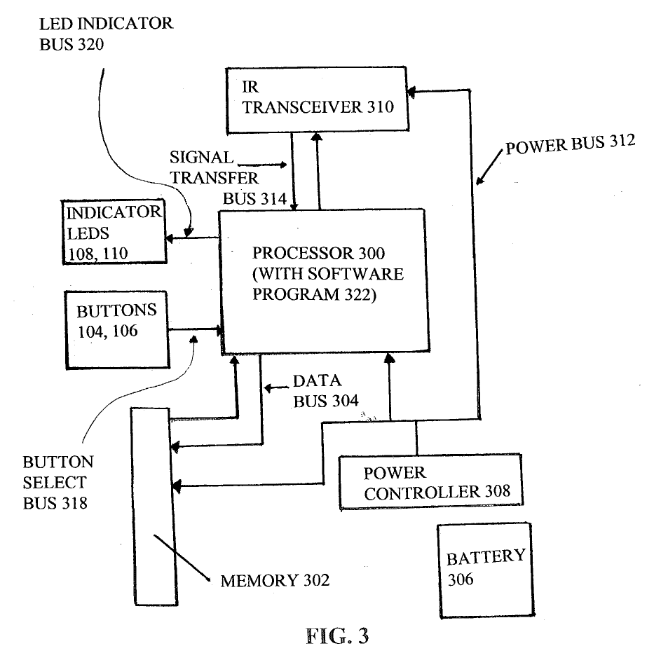

For the embodiment, communications and data storage functions of device 100 is controlled by a combination of hardware and software elements contained therein. Referring to FIG. 3, device 100 comprises a processing circuit (shown as processor 300), memory 302, data bus 304, battery 306, power controller 308, IR transceiver 310, power bus 312, signal transfer bus 314, button-select bus 318 and LED indicator bus 320. Software program 322 (described below) operates with the hardware elements to control the operation of device 100 and for the embodiment, it is stored within EPROM memory (not shown) local to processor 300. In other embodiments, software program 322 may be stored in a separate non-volatile memory which is accessible by processor 300, such as memory 302. Processor 300 may also include local volatile memory (not shown) that may be used by software program 322, for example, to store temporary data and program variables during operation of device 100.

Referring to the hardware elements, battery 306, power controller 308 and its associated interface circuit provides power to processor 300, memory 302, and IR transceiver 310 through power bus 312. Processor 300 is preferably a microprocessor having a small physical footprint and low power consumption characteristics, such as a PICmicro (trademark of Microchip Technology Inc., Chandler, Ariz.) micro-controller. Buttons 104, 106 are connected to processor 300 on button-select bus 318, and LEDs 108, 110 are connected to processor 300 on LED indicator bus 320, for signal transfer with processor 300. Preferably, power controller 308 provides false power-on prevention circuitry that only latches power from battery 306 to power bus 312 if it detects through button-select bus 318 that button 104 or 106 has been depressed for at least two seconds. Other power circuits, which may or may not utilize separate batteries, power controllers and power buses, may be used in other embodiments to supply power to device 100.

As noted above, when data transmission to and from device 100 is desired, either button 104 or 106 is activated by depressing the button for at least two seconds. After activation of button 104 or 106 and power is latched to hardware elements of device 100, processor 300 recognizes through button-select bus 318 which of button 104 or 106 was activated. Processor 300 then signals LED 108 to glow indicating that a button has been activated, by providing a signal through LED indicator bus 320 to LED 108. If an error is detected during the operation of device 100, then processor 300 signals LED 110 to glow and indicate that an error has occurred, by providing a signal through LED indicator bus 320 to LED 110. Preferably, LED 108 glows in green and LED 110 glows in red. Also, hardware and software elements of device 100 causes LED 110 to continuously glow in red when memory 302 is full and cannot store any additional data sets. LEDs 108, 110 provide a simple and cost-effective indication of the status of device 100 that is detectable by a user of the device. It will be appreciated that other small, cost-effective light emitting devices may also be used to provide a detectable indication. Other embodiments may use other indication circuits, which may include non-alphanumeric indicators, such as a buzzer or a vibrating device.

To enable signal transmission and reception, processor 300 is also connected to IR transceiver 310 via signal transfer bus 314. Preferably, IR transceiver 310 is capable of sending or receiving encoded IR signals through port 112. In other embodiments, transmission may be enabled by other transmission circuits and receiving circuits, may or may not be combined into a single hardware element such as IR transceiver 310.

To enable data storage and retrieval, processor 300 communicates with memory 302 via data bus 304. Different electronic storage devices, or combinations thereof, may be used for memory 302. Preferably non-volatile memory chips such as flash memory are used for memory 302. It will be appreciated by those skilled in the art that various combinations of sizes and configuration of memory chips may be used for memory 302.

For the embodiment, device 100 stores two sets of contact data for selective transmission in memory 302. As explained further below, each set of contact data can be provided to device 100 via a personal computer. When a set of contact data is uploaded from a personal computer to device 100, the set is associated with one of buttons 104 or 106 by a command signal issued by a computer interface program 700 (further described below) operating on the personal computer.

It will be appreciated that each of the hardware elements described above may have additional interface electrical circuits (not shown) enabling each element to communicate with the other elements and be provided power. It will also be appreciated that other hardware elements, or combinations of hardware elements, may be substituted for the elements described above in other embodiments of the invention.

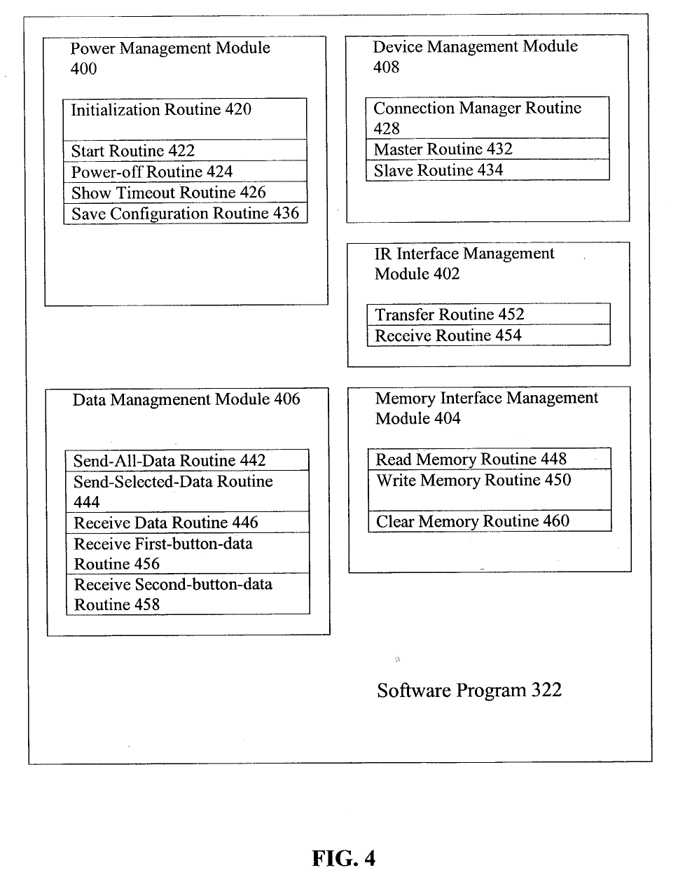

For the embodiment, device 100 is further controlled by software program 322, which provides an executable set of instructions for processor 300. Referring to FIG. 4, software program 322 includes: a power management module 400, which provides control of the power on and power off sequences of device 100; an IR interface management module 402, which provides control of transmissions to and from device 100; a memory management module 404, which provides access to memory 302; a data management module 406, which provides control of transmission and receipt of specific data sets; and a device management module 408, which provides routines to establish and control communications on device 100.

During operation of software program 322, a number of variables are stored in memory 302 or local memory of processor 300 by software program 322. These variables are updated, accessed and cleared, as necessary, by modules in software program 322. The variables include:

Total_data_sets: an integer variable that relates to the total number of data sets that are stored in memory 302;

Num_connects: an integer variable that relates to the total of attempts device 100 has made to connect to another apparatus;

Memory_address_pointer: a pointer variable that relates to the next available address of memory 302;

Source_pointer: a pointer variable that relates to a particular block and segment of memory 302; and

Home_flag: a boolean variable that relates to which of the at least one data set associated with button 104 or 106 is selected when either button is activated.

Memory 302 is divided into a number of indexed segments for storing data sets, and each segment is further divided into accessible blocks. For the embodiment, each segment is defined to span sufficient memory space to store one data set. Preferably, each segment is 512 bytes and each block is 64 bytes. For example, when memory 302 comprises 32768 bytes, then there are 64 segments, which may be indexed 0 to 63, and each segment may then be further divided into eight blocks. Software program 322 stores data into segments of memory 302 sequentially. That is, data sets that are received by device 100 are inserted into sequential segments of memory 302.

Configuration information of device 100 and other variables such as total_data_sets are stored in the first segment, a data set associated with button 104 is stored in the second segment and a data set associated with button 106 is stored in the third segment. Other data sets that are received by device 100 during data exchanges (described below) are then stored in subsequent segments. The memory_address_pointer variable tracks the next available memory segment that can be used and the source_pointer variable identifies which block and which segment in memory 302 is to be accessed during a memory operation of software program 322. It will be appreciated that other memory addressing schemes, which may or may not utilize segments and blocks, may be utilized in other embodiments.

To activate device 100, either button 104 or 106 is activated; when either button 104 or 106 is depressed and held for at least two seconds, power is latched from battery 306 to power bus 312 by power controller 308. After power is latched to power bus 312, other hardware elements of device 100 become operational and software program 322 begins execution and initializes hardware elements of device 100 for data exchange. Device 100 is automatically shut-off after a period of inactivity. Any latching circuit know in the art may be used.

After device 100 powers on, software program 322 invokes power management module 400. Power management module 400 provides an initialization routine 420 to configure memory 302, IR transceiver 310 and other hardware and software elements of device 100. Initial values for variables used by software program 322 are also loaded with initial values by initialization routine 420. For example, the num_connect variable tracks the number of connection attempts made and is initially set to zero. Power management module 400 further provides a start routine 422 that checks which of button 104 or 106 was activated through button-select bus 318, and then updates the home_flag variable accordingly to indicate which data set associated with the activated button is being identified for transfer. Start routine 422 also requests processor 300 to signal LED 108, through LED indicator bus 320, to glow and indicate that device 100 has been activated.

Power management module 400 also provides: a save configuration routine 436 that saves certain variables, such as total_data_sets, to the first segment of memory 302 by calling a write memory routine 450 of memory interface management module 404; a power-off routine 424 that invokes save configuration routine 436 when there is a power-off request, and causes power controller 308 to reset (i.e. turn off) the power latch, thus powering off device 100; and a show timeout routine 426 that causes processor 300 to signal to LED 100 to glow and indicate to a user that an error has occurred, before invoking power-off routine 424 to power off device 100.

Referring now to device management module 408, it comprises a connection manager routine 428, a master routine 432 and a slave routine 434. Each routine is described in turn.

First, connection manager routine 428 provides control for establishing and maintaining communications between device 100 and another apparatus. As described above, a master/slave synchronization protocol is used to synchronize communications between devices 100. For device 100 to establish communication with another apparatus, connection manager routine 428 initiates a series of connection attempts. For each connection attempt, connection manager routine 428 controls the generation of handshaking signals and the interpretation of received signals in a series of cycles. In particular, connection manager routine 428 first transmits a link request signal from device 100, then waits for a first wait period of time to receive an acknowledgement signal. If an acknowledgement signal is not received within the first wait period of time, then connection manager routine 428 begins to listen for a link request signal at device 100 instead. If a link request signal is not received after a second wait period of time, then the connection attempt is deemed to have failed and a cycle is completed. Connection manager routine 428 tracks the number of cycles that has occurred by incrementing the num_connects variable by one each time a connection attempt fails. When a connection attempt is deemed to have failed, connection manager routine 428 determines if a specified number of cycles have been reached, and if so invokes show timeout routine 426 to indicate an error and power off device 100. If the specified number of cycles has not been reached, then another connection attempt is made. The specified number of cycles may be set to a value of “1” or more.

Connection manager routine 428 also determines whether an activated device 100 is a master or a slave for the synchronization. Master routine 432 and slave routine 434, invoked by communication manager routine 428, control communications for device 100 after it has been determined whether device 100 is a master or a slave.

If connection manager routine 428 determines that device 100 is to operate as a master device, then master routine 432 is called. Master routine 432 controls the communication process between device 100 and the slave device after the initial sychronization. During operation of master routine 432, a number of command signals, relating to the sending or receiving of a data set, are issued from device 100 to the slave device for the slave device to act upon. The command signals include a send data set request signal, a receive data set signal and an end program request signal. If device 100 is to operate as a slave device, then slave routine 434 is called and it causes device 100 to listen for and respond to command signals issued from a master device. Preferably, slave routine 434 is also able to detect a timeout condition, evidenced by a specific period of time whereby no commands are received from a master device. If such a status is detected, then slave routine 434 invokes show timeout routine 426 to illuminate LED 110 to indicate an error, and to power off device 100.

Turning now to data management module 406, it comprises a send-all-data routine 442, a send-selected-data routine 444, a receive data routine 446, a receive first-button data routine 456 and a receive second-button data routine 458. Each routine is discussed in turn.

Send-selected data routine 444 provides control for transmitting a data set stored in memory 302 and detecting a transmission error. The data set to be transmitted is identified by the source_Pointer variable, which is set to the segment in memory 302 that is storing the data set. In operation, send-selected data routine 444 calls a read memory routine 448 (described below) to read the data set identified by the source_pointer variable, block-by-block, from memory 302 and a transfer routine 452 (describe below) to transmit the data set, block-by-block, from device 100. Send-selected data routine 444 provides error detection by waiting for a specified period of time to receive an acknowledgement signal after each block is transmitted. If an acknowledgement signal is not received after a block is transmitted, then a power-off indication is generated and the program stops. (In another embodiment, alternatively, send-selected data routine 444 causes the block to be resent and waits again for an acknowledgment signal. If an acknowledgement signal is not received after a block has been resent a specified number of times, then connection manger routine 428 is notified that a transmission error has occurred and that a connection attempt has failed. Thereafter, connection manager routine 428 determines if another connection attempt will be made, based on the number of connection attempts that has previously been made, as described above.)

Send-all-data routine 442 provides control for transmitting every data set that is stored on memory 302 from device 100. In operation, send-all-data routine 442 first sets the source_pointer variable to the first block of the second segment of memory 302. The total_data_sets variable is accessed and a program loop is performed to operate for a number of cycles that reflects the value of the total_data_sets variable. Within each cycle, send-selected-data routine 444 is invoked to send a data set that is stored in a particular segment of memory 302. Each time a data set is successfully transmitted, a loop cycle is completed and the source_pointer variable is updated to reflect the next memory segment to select the next data set for transmission in the next cycle of the loop. Send_all_data routine 442 completes when the program loop completes all its cycles by transmitting every data set that is stored in memory 302.

Receive data routine 446 provides control for device 100 to receive a data set, store the data set into memory 302 and detect a transmission error. In operation, routine 446 calls receive routine 454 (described below) to receive a data set sent from another apparatus and write memory routine 450 to store the received data set to memory 302. Receive data routine 446 receives a data set and stores it in memory 302, block-by-block, and generates and transmits an acknowledgement signal from device 100 after each block is successfully received and stored in memory 302. After a data set is successfully received, receive data routine 446 increments the memory_address pointer and total_data_sets variables to reflect that another segment of memory 302 has been used to store another data set. Receive data routine 446 provides error detection by waiting a specified period of time for an expected block to be received. If a data block is not received by receive routine 454 after the specified period of time, then receive data routine 446 notifies connection manager routine 428 that a transmission error has occurred and that a connection attempt has failed. Thereafter a power-off indication is generated and the program stops. (Alternatively, in another embodiment, connection manager routine 428 may then increment the num_connect variable and make another connection attempt, depending on whether a specified number of connection attempts has been made.)

Receive first-button-data routine 456 provides control for device 100 to receive a data set to be associated with a first button of device 100, such as button 104. Routine 456 operates in a similar manner to receive data routine 446, and calls receive routine 454 and write memory routine 450 to receive and store the data set into memory 302, block-by-block. Additionally, in operation receive first-button-data routine 456 sets the source_pointer variable to identify the second segment of memory 302, which for the embodiment is associated with button 104 so as to associate the received data set with button 104. Also, in a similar manner as receive data routine 446, error detection is provided in that if an expected block is not received by receive first-button-data routine 456 for a specified period of time, then connection manager routine 428 is notified that a connection attempt has failed, as describe above.

Receive second-button-data routine 458 provides control for device 100 to receive a data set to be associated with a second button of device 100, such as button 106. The routine operates in a similar manner as receive first-button-data routine 456, except that the source_pointer variable is set to identify the third segment of memory 302, such that the received data set is stored in the memory segment that is associated with button 106.

Referring now to memory interface management routine 404, it provides read memory routine 448, write memory routine 450 and a clear memory routine 460. Read memory routine 448 provides control for processor 300 to retrieve data contents of a block in a segment of memory 302. In operation, read memory routine 448 uses the source_pointer variable to identify a block and causes the contents stored in the identified block of memory 302 to be transmitted to processor 300 via data bus 304. Write memory routine 450 provides control for writing a block of data received from another routine or module, for example receive data routine 466, to memory 302. In operation, write memory routine 450 causes a data block to be transferred via data bus 304 from processor 300 to the block and segment of memory 302 identified by the source_pointer variable. Clear memory module 460 provides control for clearing the contents of memory 302. In operation, clear memory module 460 clears the data content of each segment of memory 302 except for the first three segments, resets the total_data_sets variable, and also updates the memory_address_pointer variable to point to the third segment. As such, clear memory module 460 clears memory 302 of every data set except for configuration information and data sets associated with buttons 104, 106 that are stored in the first three segments of memory 302.

Referring now to IR interface management module 402, it provides control for the transfer and receipt of communication signals at device 100. Preferably, IR interface management module 402 also utilizes a communication protocol for communications between device 100 and other devices that comply with Infrared Data Association (“IRDA”) standards. IR interface module 402 includes transfer routine 452 and receive routine 454. Transfer routine 452 provides control for transmitting a block of data from device 100. In operation, transfer routine 452 encodes a data block that is to be transmitted, causes the encoded block to be transferred to IR transceiver 310 through signal transfer bus 314, and then causes IR transceiver 310 to transmit the encoded block from device 100 as communication signals. Receive routine 454 provides control for receiving a data block at device 100. In operation, receive routine 454 causes IR transceiver 310 to receive communication signals constituting a data block, and transfers the received block to processor 300 through signal transfer bus 314. Receive routine 454 then decodes the received block, and generates an acknowledgement signal that it causes IR transceiver 310 to transmit from device 100.

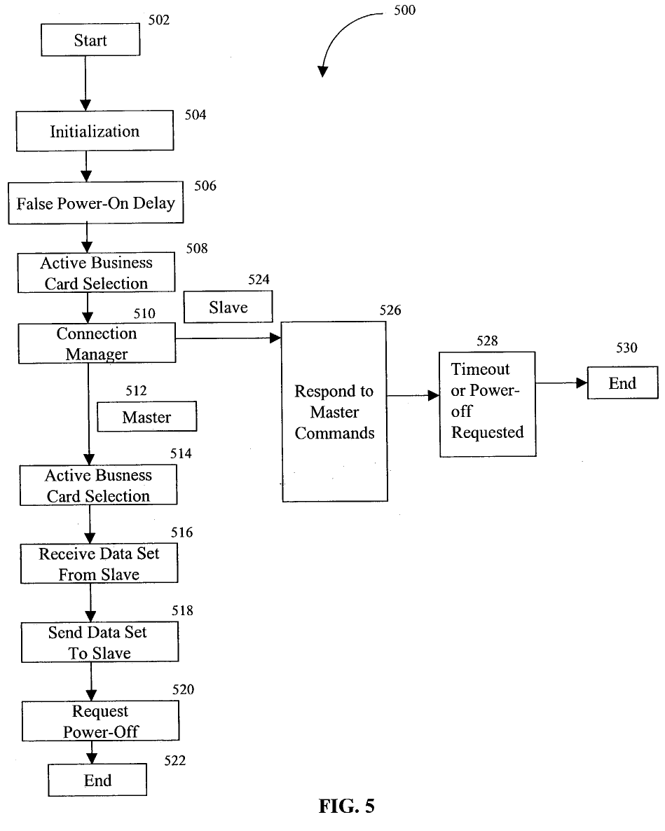

Referring to FIG. 5, flow chart 500 illustrates the general hardware power-on sequence and the operation of the modules and routines of software program 322 previously described. Software program 322 begins operation at step 502 after either button 104 or 106 is depressed, by first powering on device 100 and synchronizing with another apparatus. In step 504, power controller 308 recognizes that either button 104 or 106 has been depressed, and in step 506, power controller 308 determines if button 104 or 106 is being depressed for longer than a two-second false power-on period. If the button is not held depressed for more than the two-second false power-on period, then power controller 308 does not latch power to the rest of device 100 and device 100 is not activated; operation then ends at step 506. If button 104 or 106 is held for more than the two-second false power-on period, then in step 508, initialization routine 420 of power management module 400 is called to initialize device 100 for operation. Start routine 422 initiates and determines which of button 104 or 106 was activated and updates the home_flag variable to reflect which button was activated. At step 510, connection manager routine 428 of device management module 408 is invoked and connection manager routine 428 determines at step 510 whether device 100 is to operate as a master device or a slave device (as described below).

If device 100 is determined to be a master device, then branch 512 is taken and master routine 432 of device management module 408 is invoked to issue command signals to a slave device. In step 514, master routine 432 reads the variable home_flag to determine which data set stored on device 100 is to be transmitted from device 100. Then in step 516, master routine 432 receives a data set from the slave device by issuing a send data set request signal to cause the slave device to send a data set from the slave device and master routine 432 then calls receive data routine 446 to receive this data set. Then in step 518, master routine 431 sends the data set associated with the button that was activated on device 100 to the slave device. In step 518, master routine 431 issues a receive data set request signal indicating that it will be transmitting a data set. Master routine 432 then sets the source_pointer variable to the first block of the memory segment identified by the variable home_flag, and invokes send-selected-data routine 444 to send the data set. Thereafter, in step 520, master routine 432 requests the slave device to power-off, by issuing an end program request signal to cause the slave device end program operation. Master routine 432 then subsequently calls power-off routine 424 of power management module 400 to power off device 100, and then software program 322 ends operation at step 522.

Referring back to step 510, if device 100 is determined to be a slave device, then branch 524 is taken and slave routine 434 is activated to respond to and act upon command signals that are received from a master device. Different command signals may received by device 100 during operation of slave routine 434, depending on whether the master device is a similar device 100 or another apparatus such as a personal computer. In step 526, slave routine 434 responds to the command signals issued by the master device until either a timeout is detected or a power-off request is received at step 528. A timeout condition is determined to have occurred when there are no further commands received from the master device for a specified period of time. If a timeout condition is detected, then software program 322 calls show timeout routine 426 to indicate an error, and device 100 then powers off in step 530. If a power off request is received, then slave routine 434 invokes power off routine 424 to power off device 100 in step 530.

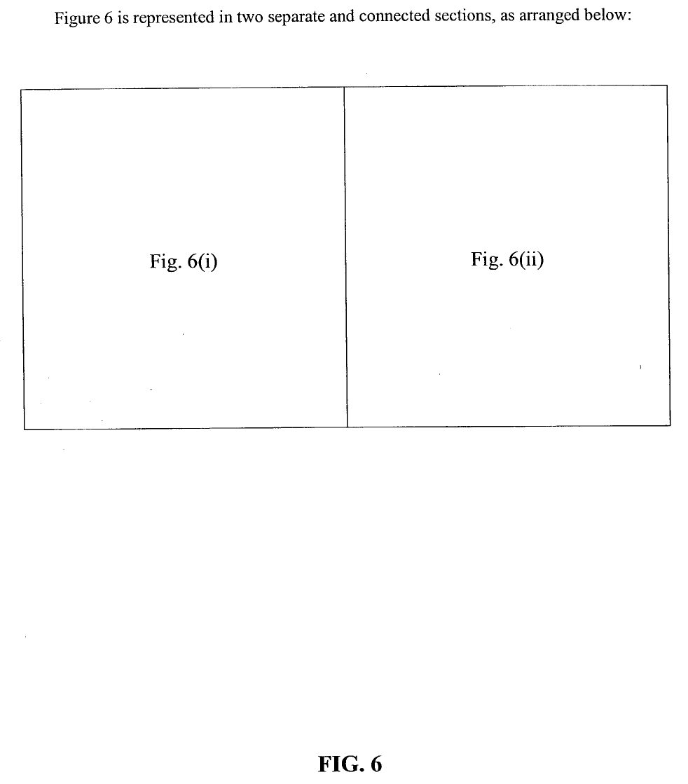

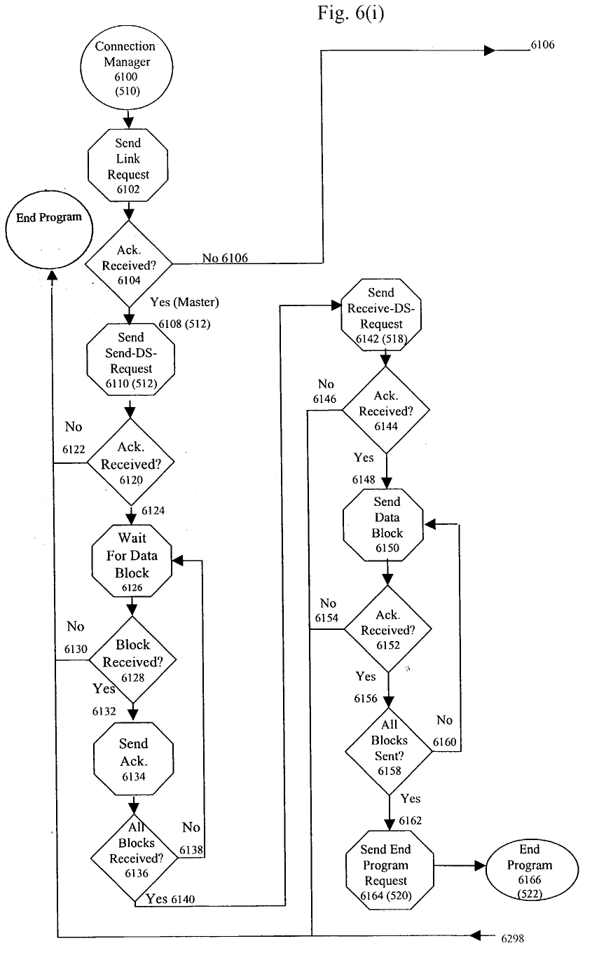

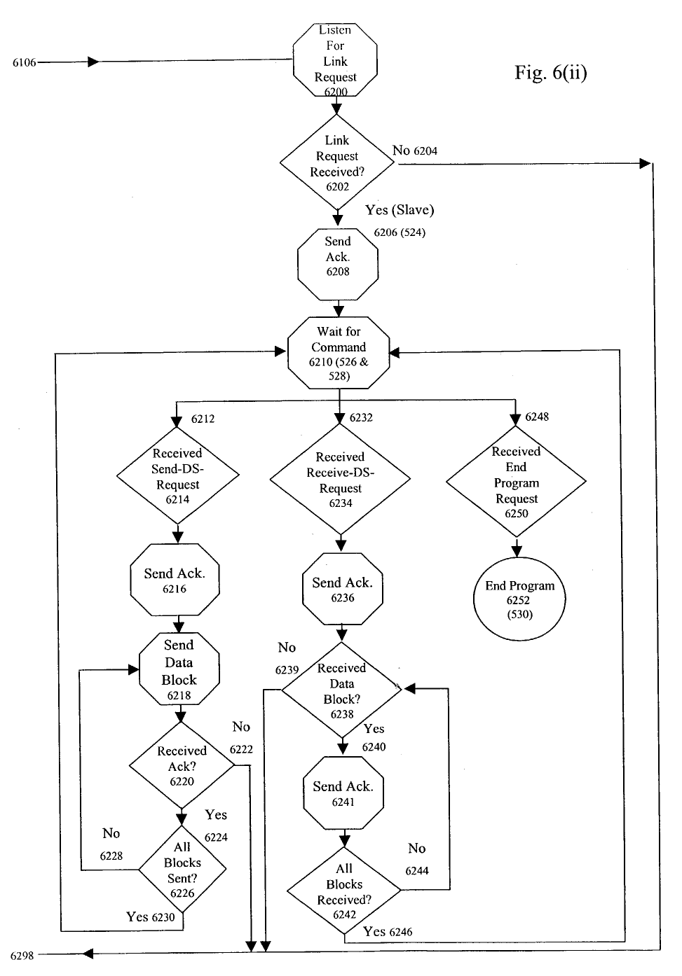

Referring to FIGS. 6(i) and 6(ii), further details on the operation of master and slave routines 432 and 434 during communications between device 100A and device 100B are provided in a second flow chart. Numerals denoting steps shown in FIG. 5 are shown within brackets besides numerals denoting the start of correlating steps in FIGS. 6(i) and 6(ii).

A description on the operation of software program 322 from the perspective of device 100A is provided. FIGS. 6(i) and 6(ii) shows software program 322 in operation immediately after connection manager routine 428 has been invoked at both device 100A and 100B at step 6100 and the devices are about to begin synchronization. For device 100A, at step 6102 connection manager routine 428 begins a connection attempt with device 100B by sending a link request signal from device 100A. At diamond 6104, connection manager routine 428 determines if an acknowledgement signal is received at device 100A. If an acknowledgement signal is not received at diamond 6104, then branch 6106 is taken and communication manager routine 428 waits for a link request signal at step 6200. At diamond 6202, if a link request signal is received, then branch 6206 is taken, device 100A is categorized as a slave device and slave routine 434 is called. In any event, if a link request signal is not received at diamond 6202, then the connection attempt is deemed to have failed. As such, branch 6204 is taken joining to branch 6298, an error indication is generated (such as by activating LED 110) and the routine terminates. (In another embodiment, a branch may be taken (not shown), returning operation of the routine to step 6100 to attempt another connection attempt without terminating the routine. In the another embodiment, connection manager routine 428 makes a specified number of connection attempts before declaring a timeout condition. If the specified number of connection attempts has not been reached, then connection manager routine 428 will make another connection attempt by proceeding again to step 6102. If the specified number of connection attempts has been reached, then show timeout routine 426 is invoked to illuminate LED 110 to indicate an error condition and to power off device 100A.) It will be appreciated that in the handshaking process just described, unless there is a timeout condition, device 100A or 100B becomes the master and the other device becomes the slave.

Referring back to diamond 6104, if an acknowledgement signal is received and branch 6108 is taken, then master routine 432 of device management module 408 is called and device 100A becomes the master device. Thereafter, at step 6110, master routine 432 attempts to send three command signals to the slave device: (i) a send data set request signal; (ii) a receive data set request signal; and (iii) an end program request signal.

At step 6110, the send data set request signal (shown as “Send-DS-Request”) is issued to the slave device to request that the slave device transmit a data set. At diamond 6120, if an acknowledgement signal is not received at the master device, then the connection attempt is deemed to have failed. As such, branch 6122 is taken, an error indication is generated (such as by activating LED 110) and the routine terminates. (In another embodiment, a branch may be taken (not shown), returning operation of the routine to step 6100 to attempt another connection attempt without terminating the routine.) If an acknowledgement signal is received, then branch 6124 is taken and master routine 432 invokes receive data routine 446, which waits for a data block to be received in step 6126 by calling receive routine 454. As described above, receive routine 454 waits for a block to be received at the master device for a specified period of time. If a block is not received before the expiry of this period of time at diamond 6128, then branch is taken, an error indication is generated (such as by activating LED 110) and the routine terminates. (In another embodiment, a branch may be taken (not shown), returning operation of the routine to step 6100 to attempt another connection attempt without terminating the routine.) If a block is received, then branch 6132 is taken and receive routine 454 generates and sends an acknowledgement signal in step 6134. Thereafter at diamond 6136, if more blocks of the data set are still expected, then branch 6138 is taken back to step 6126 to wait for the next block to be received. If all blocks of the data set have been received, then the requested data set has been completely received. Receive data routine 446 then ends, control is returned to master routine 432, and branch 6140 is taken from diamond 6136.

After the requested data set has been received, master routine 432 continues by sending a receive data set request signal (shown as “Receive-DS-Request”) to the slave device to synchronize reception of a data set by the slave device at step 6142. If an acknowledgement signal is not received by device 100A at diamond 6144, then branch 6146 is taken, an error indication is generated (such as by activating LED 110) and the routine terminates. (In another embodiment, a branch may be taken (not shown), returning operation of the routine to step 6100 to attempt another connection attempt without terminating the routine.) If an acknowledgement signal is received at diamond 6144, then branch 6148 is taken and master routine 432 calls send-selected-data routine 444 to transfer the data set that is associated with the button that was activated. Transfer routine 428 is called by send-selected-data routine 444 to transmit, block-by-block, the data set beginning at step 6150. If an acknowledgement signal is not received for a block that is sent, then from diamond 6152 branch 6154 is taken, an error indication is generated (such as by activating LED 110) and the routine terminates. (In another embodiment, a branch may be taken (not shown), returning operation of the routine to step 6100 to attempt another connection attempt without terminating the routine.) If an acknowledgement signal is received at diamond 6152, then send-selected-data routine 444 checks whether all blocks associated with the data set have been sent at diamond 6158. If not, then branch 6160 is taken and send-selected-data 444 returns to step 6150 to send the next block. If all blocks have been sent, then branch 6162 is taken from diamond 6158, send-selected data routine 444 ends and control is returned to master routine 432. Master routine 432 then sends an end program request signal to the slave device in step 6164. Once the end program request signal has been sent, master routine 432 ends in step 6166 and calls power-off routine 424 of power management module 400 to power off device 100A.

Referring back to diamond 6202, if device 100A receives a link request signal, then device 100A is categorized as a slave device. If device 100A is operating as a slave device, then connection manager routine 428 calls slave routine 434 and branch 6206 is taken. In step 6208, slave routine 434 first generates and sends an acknowledgement signal and then awaits requests issued from the master device in step 6210. As noted above, the master device (i.e. device 100B) may send one of three possible command signals that may be received by device 100A at step 6210: (i) a send data set request signal, (ii) a receive data set request signal; or (iii) an end program request signal. Depending on the command signal that is received, slave routine 434 continues operation in one of three possible branches. However, after a specified period of time, if no request signal is received at device 100A, then show timeout routine 426 is called to indicate an error condition and power off device 100A.

From step 6210, if device 100A receives a send data set request signal, then branch 6212 is taken. Once device 100A has received the send data set request signal at step 6214, slave routine 434 generates and sends an acknowledgement signal in step 6216, and calls send-selected-data routine 444. As noted above, the data set to be transmitted is sent in blocks by transfer routine 452 in step 6218. Send-selected-data routine 444 then waits for an acknowledgement signal from the master device at diamond 6220. If none is received then branch 6222 (joining to path 6298) is taken, an error indication is generated (such as by activating LED 110) and the routine terminates. (In another embodiment, a branch may be taken (not shown), returning operation of the routine to step 6100 to attempt another connection attempt without terminating the routine.) If an acknowledgement signal is received at diamond 6220, then branch 6224 is taken and send-selected-data routine 444 determines if all blocks have been sent in diamond 6226. If not, then branch 6228 is taken and transfer routine 452 sends the next block at step 6218 as above. If all blocks have been transferred, then send-selected-data routine 444 ends, and branch 6230 is taken and slave routine 434 continues to wait for further request signals at step 6210.

From step 6210, if a receive data set request signal is received by device 100A, then branch 6232 is taken and slave routine 434 receives the request signal in step 6234. An acknowledgement signal is generated and sent in step 6236. Thereafter, receive data routine 446 is called by slave routine 434 to receive a data set. Receive data routine 446 then calls receive routine 454 to receive a block of data in diamond 6238. Similar to the looping procedure for receiving a block of data for a master, receive routine 454 waits for a data block to be received for a specified period of time. If a block is not received before the expiry of this period of time at diamond 6138, then branch 6239 is taken, an error indication is generated (such as by activating LED 110) and the routine terminates. (In another embodiment, a branch may be taken (not shown), returning operation of the routine to step 6100 to attempt another connection attempt without terminating the routine.) If a block is received, then path 6240 is taken and receive routine 454 generates and sends an acknowledgement signal in step 6241. Receive data routine 446 then determines if all blocks to the data set have been received in diamond 6242. If not, then branch 6244 is taken and receive routine 454 receives the next block at diamond 6238. If all blocks to a data set have been received, then branch 6246 is taken from diamond 6242. Receive data routine 446 then exits and slave routine 434 returns to step 6210 to wait for further request signals.

From step 6210, if an end program request signal sent by the master device is received by device 100A, then branch 6248 is taken and slave routine 434 receives the request at step 6250. Slave routine 434 then calls power-off routine 424 of power management module 400 to power off the slave device.

It will be appreciated that the process described above includes various time-based events. The duration of each event may be modified to meet specific needs of a given implementation of the embodiment.

Referring back to FIG. 2, device 100 also provides backwards communication compatibility with a prior art electronic or computing device which either incorporates a communication port that can communicate compatible data with port 112 or is otherwise connected to such a compatible communication port (such as, for example, personal computer 202 connected to communications transceiver 204). It will be appreciated that, depending on the specifics of such a prior art electronic or computer device, specific software programs and drivers may need to be present in such a prior art device to enable communications with device 100.

During communications between device 100 and a personal computer, such as notebook computer 210 or personal computer 202, such communications are handled on device 100 by software program 322 and on the personal computer by a computer interface program 700. For the embodiment, computer interface program 700 preferably operates in the foreground as an active application whenever communications is desired with device 100. When computer interface program 700 is activated on a personal computer, program 700 issues commands to communications transceiver 204 to send and receive information to and from device 100. Computer interface program 700 operates in a similar manner to software program 322, except that computer interface program 700 permits only a personal computer to operate as a master device, and as a result, connection manager routine 428 operating on device 100 will always invoke slave routine 434 for device 100 to respond to command signals issued by the personal computer.

Computer interface program 700 performs handshaking by continuously sending a link request signal and waiting for an acknowledgement signal. Since computer interface program 700 only sends link request signals, the handshaking provided by the embodiment results in a personal computer always being a master device and device 100 always being a slave device. It will be appreciated that other synchronization techniques between device 100 and a personal computer may be used, which may include techniques providing an alternate master/slave arrangement, or techniques not employing a master/slave arrangement.

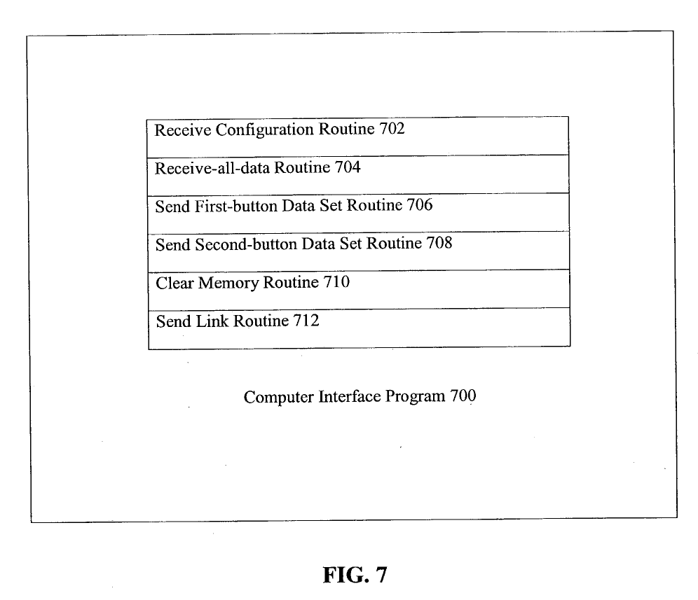

Referring to FIG. 7, further details on computer interface program 700 are provided. For the embodiment, computer interface program 700 operates on a personal computer and includes a send link routine 712, a receive configuration routine 702, a receive-all-data routine 704, a send first-button data set routine 706, a send second-button data set routine 708 and a request-clear memory routine 710. Each routine is described in turn.

Send link routine 712 provides control for sychronizing and establishing communications with device 100. In operation, send link routine 712 causes a link request signal to be sent from the personal computer, and after the signal is sent, routine 712 awaits an acknowledgment signal from a device 100 to establish that the personal computer will assume the role of a master and that device 100 will assume the role of a slave. For the embodiment, if an acknowledgement signal is not received, then send link routine 712 may also be configured to wait a period of time before causing another link request signal to be sent. Preferably, link requests signals will be sent a specified number of times, and if no acknowledgement signal is received after such specified number of signals were sent, then send link routine 712 causes a timeout error condition to be declared in computer interface program 700.

Receive configuration routine 702 provides control for requesting a device 100 to transmit its configuration data to the personal computer. When receive configuration routine 702 is invoked, a command signal is issued from the personal computer to request device 100 to transmit configuration information that is stored in the first segment of memory 302 of device 100. Slave routine 434 of device 100 responds by setting the source_pointer variable to the first block of the first segment of memory 302 and calling the send-selected-data routine 444 to transmit the contents of the segment from device 100.

Receive-all-data routine 704 provides control for requesting a transfer of every data set of device 100 to the personal computer. In operation, receive-all-data routine 704 causes the personal computer to send a command signal to device 100 to transmit every data set that is stored in memory 302 of device 100, and slave routine 434 on device 100 responds by calling send-all-data routine 442 to transmit from device 100 the data that is stored in memory 302.

Send first-button data set routine 706 provides control for sending a data set from to device 100 which is to be associated with a first button of device 100, such as button 104. In operation, send first-button data set routine 706 causes the personal computer to send a command signal that device 100 be prepared to receive a data set. The command signal also indicates that the data set is to be associated with button 104 of device 100. After the command signal is sent, send first-button data set routine 704 initiates transmission of a data set that is to be associated with the button from the personal computer. On device 100, slave routine 434 responds to the command signal by invoking receive first-button-data routine 456 to receive and store the data set to the segment of memory 302 associated with the button. Send second-button data set routine 706 provides similar functionality and operates in a similar manner, except that (i) the data set that is transmitted is a data set that is to be associated with another button of device 100, such as button 106, and (ii) in response, at device 100 slave routine 434 would invoke receive second-button-data routine 458 to store the received data set to the segment of memory 302 that is associated with button 106 of device 100.

Request-clear memory routine 710 provides control for requesting device 100 to clear its memory of data sets stored therein, except for the data sets associated with a button of device 100. In operation, request-clear memory routine 710 causes a command signal to be sent from the personal computer to slave device 100 to clear its memory contents. On device 100, slave routine 434 responds by invoking clear memory routine 460 to clear the contents of memory 302, except for the contents of the first three segments of memory 302 as described above.

In the preferred embodiment, computer interface program 700 further provides a communications utility to transfer and receive contact information to and from another personal computer information management program, such as Microsoft Outlook (trademark of Microsoft Corporation, Richmond, Wash.). Preferably, the communications utility also provides support for the virtual card (.vcf) format of data storage.

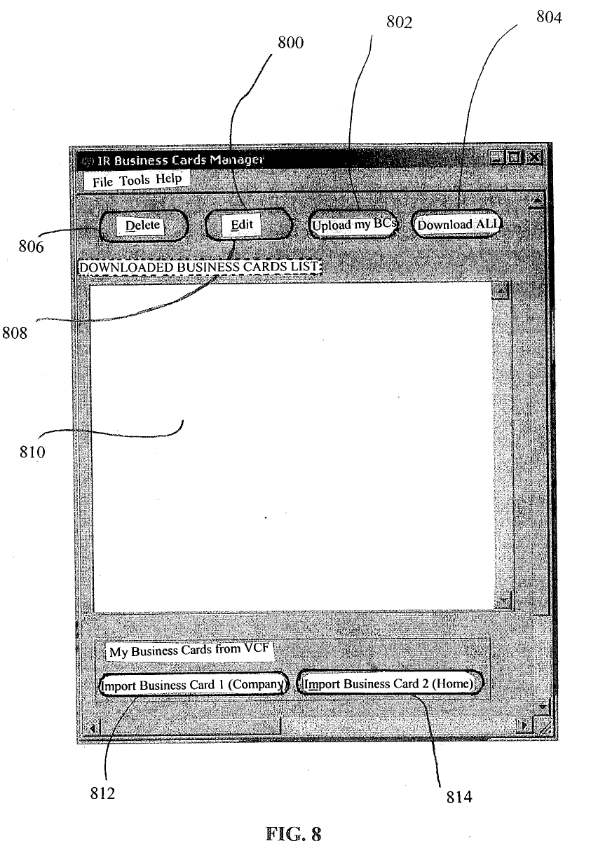

Referring to FIG. 8, an exemplary user interface of computer interface program 700 operating on a personal computer is shown. For the embodiment, program 700 further provides a user interface shown on a computer display as window 800.

In window 800, buttons 802, 804, 806, 808 provide access to selected functions of computer interface program 700. Buttons 812 and 814 are used to access the function of program 700 whereby a data set is imported from, for example, a data file in .vcf format.

Using an input device, such as a mouse or keyboard, a user can activate a button in window 800, select a data set in display area 810 or enter other information. When button 804 is depressed, receive-all-data routine 704 is invoked and after data sets are received from device 100, display area 810 shows selected information regarding each data set that was received from device 100. If a data set is selected by an input device in display area 810 and then button 808 is depressed, another window will be displayed which allows a user to edit the information in the data set. If a data set is selected in display area 810 and then button 806 is depressed, then that data set will be deleted from display area 810. Buttons 806 and 808 may be used, for example, to edit and/or deleted data sets before the data sets are transferred to another personal computer information management program. Buttons 802 and 804 causes send first-button data set routine 706 and send second-button data set routine 708 to be invoked respectively, which transfers data sets to be associated with buttons 104 and 106 to device 100. Other features of program 700 (not shown) may be accessed from the pull-down menus “File” and “Tools” that is shown in window 800.

It will be appreciated that the software elements described above may be implemented in other functional blocks. It will be appreciated that the foregoing are only examples of embodiments of the invention, and that the present invention is not limited to the embodiments described above.

We claim:

1. An apparatus for storing a plurality of sets of identification data and for transmitting a selected set from said plurality of sets of identification data to another apparatus, said apparatus comprising:
an electronic storage device for storing said plurality of sets of identification data;
a selection interface module for enabling selection by a user of said selected set from said plurality of sets of identification data;
a transmission module for transmitting said selected set from said apparatus;
an indication module providing a detectable indication to said user when said user activates said selection interface module;
a processing module for controlling operation of said electronic storage device, said selection interface module, said transmission module and said indication module; and
a power module providing power to said electronic storage device, said selection interface module, said transmission module, said indication module and said processing module.

2. The apparatus for storing a plurality of sets of identification data and for transmitting a selected set from said plurality of sets of identification data to another apparatus as claimed in claim 1 wherein said selection interface module comprises a first input device providing identification of said selected set from said plurality of sets of identification data and a second input device enabling initiation of transmission of said selected set by said apparatus.

3. The apparatus for storing a plurality of sets of identification data and for transmitting a selected set from said plurality of sets of identification data to another apparatus as claimed in claim 2 wherein said selection interface module comprises:
a first input device associated with a first set of said plurality of sets of identification data, said first set becoming said selected set upon activation of said first input device; and
a second input device associated with a second set of said plurality of sets of identification data, said second set becoming said selected set upon activation of said second input device.

4. The apparatus for storing a plurality of sets of identification data and for transmitting a selected set from said plurality of sets of identification data to another apparatus as claimed in claim 3, said apparatus further comprising a receiving module for receiving an external set of identification data from another apparatus, wherein said processing module further controls operation of said receiving module and said external set of identification data is stored in said electronic storage device.

5. The apparatus for storing a plurality of sets of identification data and for transmitting a selected set from said plurality of sets of identification data to another apparatus as claimed in claim 4 wherein said indication module comprises a light emitting source energized upon activation of said selection interface module.

6. The apparatus for storing a plurality of sets of identification data and for transmitting a selected set from said plurality of sets of identification data to another apparatus as claimed in claim 5 wherein said apparatus further comprises a synchronization module for initiating communications with said another apparatus to attempt to coordinate transmission of said selected set by said apparatus and said external set by said another apparatus.

7. The apparatus for storing a plurality of sets of identification data and for transmitting a selected set from said plurality of sets of identification data to another apparatus as claimed in claim 6 wherein said synchronization module transmits a link request signal to said external device and waits for reception of an acknowledgement signal from said external device by said receiving module for a period of wait time to establish an order of transmission of said first set by said apparatus and said external set by said another apparatus prior to transmission of said selected set by said apparatus.

8. The apparatus for storing a plurality of sets of identification data and for transmitting a selected set from said plurality of sets of identification data to another apparatus as claimed in claim 7 wherein if said synchronization module receives said acknowledgement signal within said period of wait time, then said synchronization module generates and transmits a signal to said another apparatus to begin transmitting said external data set to said apparatus.

9. The apparatus for storing a plurality of sets of identification data and for transmitting a selected set from said plurality of sets of identification data to another apparatus as claimed in claim 8 wherein after successful reception of said external data set, said transmission module begins transmitting said selected set from said apparatus.

10. The apparatus for storing a plurality of sets of identification data and for transmitting a selected set from said plurality of sets of identification data to another apparatus as claimed in claim 9 wherein said external set is stored in said electronic storage module.

11. The apparatus for storing a plurality of sets of identification data and for transmitting a selected set from said plurality of sets of identification data to another apparatus as claimed in claim 10 wherein said transmission module transmits said selected set from said apparatus utilizing wireless transmissions.

12. A system for storing a plurality of sets of identification data, said system including:
an apparatus comprising:
an electronic storage device for storing said plurality of sets of identification data;
a selection interface module enabling selection by a user of a selected set from said plurality of sets of identification data;
a transmission module for transmitting said selected set from said apparatus;
an indication module providing a detectable indication to said user when said user activates said selection interface module;
a receiving module for receiving identification data to be integrated into said plurality of identification sets from a computer;
a synchronization module for initiating communications with said computer to attempt to coordinate reception of said identification set from said computer;
a processing module for controlling operation of said electronic storage device, said selection interface module, said transmission module and said indication module; and
a power module providing power to said electronic storage device, said selection interface module, said transmission module, said indication module, said syncrhonization module and said processing module;
software operable on a computer comprising:
an input module for receiving data from said computer constituting said identification set;
a transmission module for controlling transmission of said identification set to said apparatus and for establishing synchronization with said apparatus; and
a reception module for initiating transmission of one set of said plurality of sets of identification data from said apparatus to said computer for storage by said computer;
and
an interface module associated with said computer for transmitting said identification set to said apparatus from said computer as controlled by said software and for receiving said one set from said apparatus.

13. The system for storing a plurality of sets of identification data as claimed in claim 12 wherein said transmission module of said software operable on a computer initiates transmission of a link request signal to apparatus and waits for reception of an acknowledgement signal from said apparatus by said reception module before transmitting said a signal to said identification set to said apparatus.

14. The system for storing a plurality of sets of identification data as claimed in claim 13 wherein for said apparatus, activation of said selection interface module to a selection causes said identification set to be associated with said selection by said apparatus.

15. The system for storing a plurality of sets of identification data as claimed in claim 14 wherein said software further comprises a reset module to initiate a request to said apparatus to clear said electronic memory device of said plurality of sets of identification data.

16. The system for storing a plurality of sets of identification data as claimed in claim 15 wherein reception module of said software further a routine to initiate a request to request to said apparatus to transmit all sets of said plurality of sets of identification data to said computer.
